(19) United States
(12) Patent Application Publication
(10) Pub. No.: US 2015/0100386 A1
(43) Pub. Date: Apr. 9, 2015

(54) DIGITAL FRAMEWORK FOR BUSINESS MODEL INNOVATION

(71) Applicant: International Business Machines Corporation, Armonk, NY (US)

(72) Inventors: Daniel T. Lambert, Manhattan, NY (US); Norbert Herman, Denver, CO (US)

(73) Assignee: International Business Machines Corporation, Armonk, NY (US)

(21) Appl. No.: 14/046,405

(22) Filed: Oct. 4, 2013

(51) Int. Cl. G06Q 10/06

(52) U.S. Cl. CPC G06Q 10/0637; G06Q 10/067
USPC 705/7.36

(57) ABSTRACT

Automated business model generation includes identifying constituent attribute text strings of an input offer that are relevant to pre-coded cost and revenue components within a matching threshold, and generating a business plan by linking said relevant pre-coded business plan components. The processor combines cost values assigned to the linked cost components and revenue values assigned the linked revenue components to generate composite cost and revenue values for the generated business plan as a function of probability weighting factors that are selected for the cost and revenue components as a function of entity identity attributes of the input offer.

### FIELD OF THE INVENTION

The present invention relates to automated and programmable mechanisms that define financial data inputs and analyze the inputs as a function of the definitions to generate business models.

### BACKGROUND

Business model design and innovation is complex when multiple factors related to amounts of data and variables are considered, analyzed and structured in order to help shape strategic approaches. Aspects of business insight available from social media inputs, as filtered through changing formats imposed by globalization and technological change factors, may impose difficulties in understanding, analyzing and innovating a given business model over time. Solutions may require costly amounts of time and expertise in order to identify best approaches going forward, while reducing possible amounts of innovation due to the restrictions imposed by amounts of variables and levels of granularity needed for effective and collaborative input from stakeholders.

### BRIEF SUMMARY

In one aspect of the present invention, a method for automated business model generation includes a processor comparing text strings of an input offer against each of a plurality of pre-coded business plan components to identify constituent attribute text strings of the input offer that are relevant to one or more cost components and one or more revenue components of the pre-coded cost and revenue business plan components within a matching threshold. The processor generates a business plan for the input offer by linking the pre-coded business plan components that are identified as associated with the input offer constituent attribute text strings within the matching threshold, wherein the linked components include the cost and revenue components. The processor combines cost values assigned to the linked cost components and revenue values assigned to the linked revenue components to generate composite cost and revenue values for the generated business plan as a function of probability weighting factors that are selected for the cost and revenue components as a function of entity identity attributes of the input offer.

In another aspect, a system has a processor, computer readable memory and a computer-readable storage medium with program instructions, wherein the processor, when executing the stored program instructions, compares text strings of an input offer against each of a plurality of pre-coded business plan components to identify constituent attribute text strings of the input offer that are relevant to one or more cost components and one or more revenue components of the pre-coded cost and revenue business plan components within a matching threshold. The processor generates a business plan for the input offer by linking the pre-coded business plan components that are identified as associated with the input offer constituent attribute text strings within the matching threshold, wherein the linked components include the cost and revenue components. The processor combines cost values assigned to the linked cost components and revenue values assigned to the linked revenue components to generate composite cost and revenue values for the generated business plan as a function of probability weighting factors that are selected for the cost and revenue components as a function of entity identity attributes of the input offer.

In another aspect, a computer program product has a computer-readable storage medium with computer readable program code embodied therewith, the computer readable program code including instructions that, when executed by a processor, cause the processor to compare text strings of an input offer against each of a plurality of pre-coded business plan components to identify constituent attribute text strings of the input offer that are relevant to one or more cost components and one or more revenue components of the pre-coded cost and revenue business plan components within a matching threshold. The processor generates a business plan for the input offer by linking the pre-coded business plan components that are identified as associated with the input offer constituent attribute text strings within the matching threshold, wherein the linked components include the cost and revenue components. The processor combines cost values assigned to the linked cost components and revenue values assigned to the linked revenue components to generate composite cost and revenue values for the generated business plan as a function of probability weighting factors that are selected for the cost and revenue components as a function of entity identity attributes of the input offer.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of an aspect according to the present invention for an automated business model design.

FIG. 2 provides a block diagram illustration of a business model display according to an aspect of the present invention.

FIG. 3 is a block diagram illustration of a computer system implementation of an aspect of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes transitory, propagation or carrier wave signals or subject matter and includes an electronic, magnetic, optical or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that does not propagate but can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic or optical forms or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flowchart and/or block diagram block or blocks.

A business model describes the rationale of how an organization creates, delivers, and captures value. Business model design should allow for varied levels of granularity as well as the ability to capture critical financial data and impacting factors. Aspects of the present invention provide structured processes that effectively analyze a business model to provide objective valuations from clearly defined inputs, thereby providing dynamic business model design that identifies opportunities and allows innovation processes to define and revise target states communicated to an organization for execution.

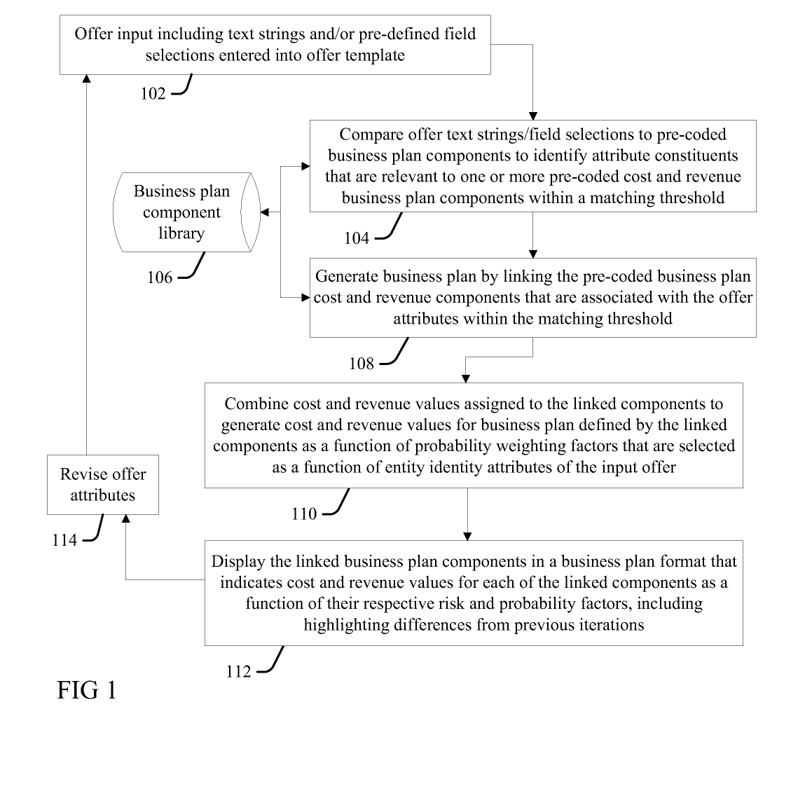

FIG. 1 illustrates an aspect of the present invention for automated business model design. At 102 an offer (or value proposition) is entered into an offer template provided by a processor, for example via a dashboard or browser window that receives graphical user interface (GUI) inputs or another mechanism as will be appreciated by one skilled in the art. The offer includes text strings (including phrases, keywords and keyword combinations), or pre-defined field selections (via radio button selections, pull-down menus, etc.) that are descriptive of attributes of the offer that are relevant to a business plan for implementing the offer. The attributes include identities or descriptions of goods or services to be provided and the entities required for delivery of goods or execution of services or to provide channels of distribution, the identities of the intended customers or clients of the goods or services, etc.

At 104 the offer input text strings and pre-defined field items are compared against a library 106 of pre-coded business plan components that have associations with the pre-defined field items and/or descriptive cost and revenue phrases or keyword combinations, to thereby identify constituent attribute text strings and pre-defined field items of the offer that are relevant to the pre-coded cost and revenue business plan components within a matching threshold. In some aspects, Extract, Transform and Load (ETL) processes and mechanisms (programmable devices) extract the input data from an original input source, transform the extracted data to fit operational needs of the library 106 system and loading the transformed data into the library 106 as end target to compare the data to component and object data within the library 106. Aspects generally determine match values at 104 as percentages of relevance to each of the pre-coded cost and revenue factor attributes, for example a percentage of similarity of a first phrase identified as a cost phrase to another pre-coded cost phrase, or a percentage of likelihood to cause an event associated with a pre-coded cost phrase, etc.

At 108 a business plan is generated for the input offer by linking or otherwise combining the business plan components associated with the offer attributes within the matching threshold at 104, wherein the linked components include at least one cost component and at least one revenue component, generally pluralities of each.

Each of the business plan cost components within the library 106 have assigned cost values and revenue values, and each of the business plan revenue components within the library 106 have assigned cost revenue values and probability values. At 110 the cost and revenue values assigned to the linked components are combined or otherwise used to generate cost and revenue values for the business plan defined by the linked components as a function of probability weighting factors or values that are selected as a function of entity identity attributes of the input offer, and in some aspects as a function of risk factors or values. At 112 the linked business plan components are displayed in a business plan format that indicates cost and revenue values for each of the linked components as a function of their respective probability and/or risk values.

In some aspects, risk and probability weighting factors are used to adjust/revise the pre-coded cost and revenue valuations assigned to each of the linked business plan components as a function of the matching offer attributes. Said risk and probability factors may be used to quantify a level of certainty, confidence or importance of a linked component, or to identify which of the linked elements or their cost or revenue values should be highlighted or displayed differentially. Thus, highest risk components may be displayed at 112 in a distinctive highlighting relative to other lower risk components.

In another aspect, if a total cost value determined for the business plan as whole, or for a linked cost component, is small relative to an operating budget of a first entity associated with the offer or the generated business plan, then an associated risk value may be diminished in importance, the risk factor itself given a low effective weighting in determining objective values of the business plan, or eliminating highlighting of this component in the display at 112. In contrast, if however the operating budget of a second entity associated with the offer or the generated business plan is lower, wherein the total cost values represent a higher, appreciable percentage of the operating budget of the second entity, then an associated risk value may be increased in importance or given a higher effective weighting in determining objective values of the business plan, highlighting of this component in the display at 112 as a key consideration in evaluating the business plan.

The severity of a risk or exposure may also be used to weight a particular revenue or risk factor. For example, if a particular attribute is present that will put an entire contract at risk, then this attribute score may be highlighted in the display at 112, or it may more highly weight the value if a cost, or diminish the weight of the revenue to reflect a lower probability that the revenue item will be realized. Overall business plan scores generated and displayed at 112 may be composite values of all related components, or of related groupings of linked components, in one aspect to enhance comparability of linked components or other business plan iterations.

The present example links the display process 112 with the offer input process at 102 to provide a feedback process, so that other, subsequent iterations of the business plan may be presented at 112 after variations of the offer attributes are input at 114, wherein the subsequent presentment highlights differences in the cost and revenue values generated for the respective business plan iterations. Such aspects readily reveal relative advantages or determents caused by variations to the offer attributes between the respective iterations. For example, in a first iteration, one risk attribute may weigh the cost value for a linked cost component to account for 10% of a total predicted cost of the plan, while in a second iteration the weight factor changes to adjust the cost value to account for a different (higher or lower) percentage of all costs due to a change in input offer attributes.

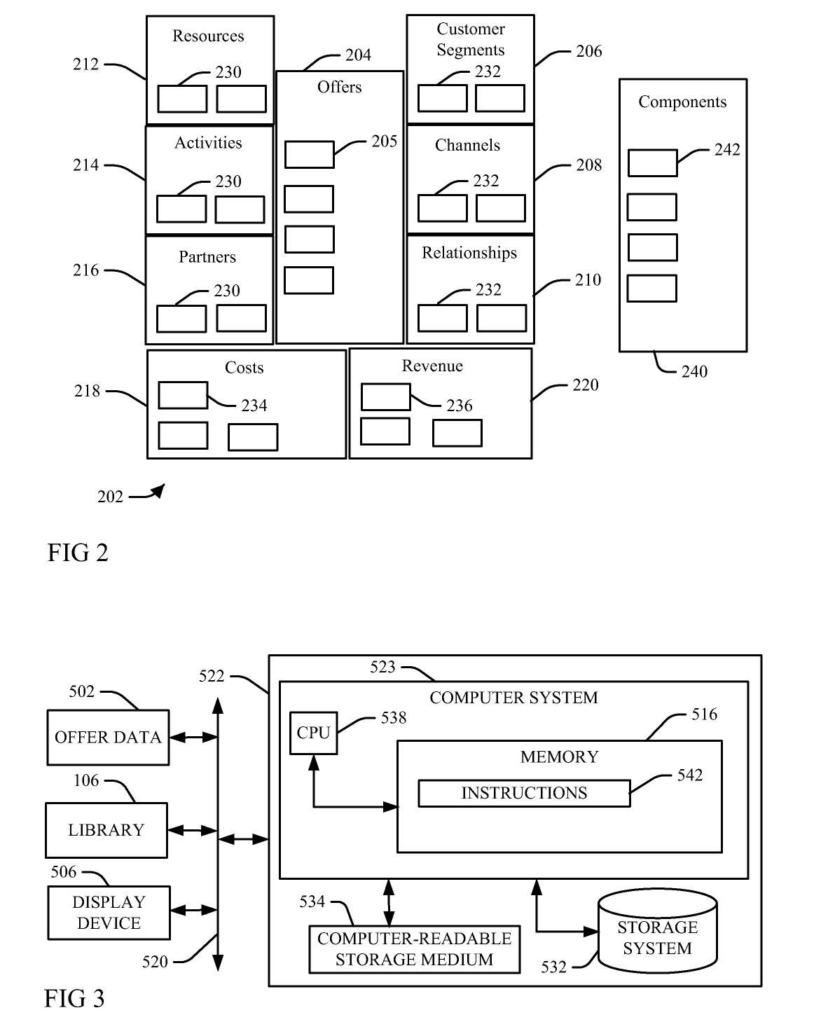

One aspect of the present invention illustrated in FIG. 2 integrates components in a business model display or canvas 202 approach described in “Business Model Generation,” Alex Osterwalder and Yves Pigneur (Wiley 2010) into a Visio®-coded solution using the Visio® shell that can be used to facilitate Business Model Innovation and Execution (BMIE). (VISIO is a trademark of the Microsoft Corporation in the United States or other countries.) The solution enables cross site collaboration via an internet or other network connection, and enables the introduction or additional business innovation templates. However, this is not a limiting example and one skilled in the art will appreciate that other programmable device applications will be appropriate for executing aspects.

The canvas 202 of FIG. 2 is an interactive dashboard with nine block categories (204 through 220). The offer block 204 is populated with offer objects 205 selected in response to the offer text string or field inputs (at 102 of FIG. 1) that each represent attributes of the offer including price, product description, assembly mode, etc. The remaining blocks (206 through 220) are automatically populated with respective ones of cost objects 230 or revenue objects 232 of associated ones of the business components linked at 108 of FIG. 1, and cost value objects 234 or revenue value objects 236 that provide the combined costs and revenues generated at 110. The canvas thereby displays the generated business plan at 112 as the objects 230 and 232 that are representative of the linked components, along with the costs of the business plan as cost value objects 234 within a costs block 218 that are derived from values from the cost objects 230, and revenues of the business plan as revenue value objects 236 within a revenues block 220 that are derived from values from the revenue objects 232.

More particularly, three cost structure blocks (resources 212, activities 214 and partners 216) are populated with the linked cost component objects 230, and four revenue structure blocks (offers 204, channels 208, customer relationships 210 and customer segments 206) are populated with the linked revenue component objects 232. The costs block 218 is populated with one or more of cost value objects 234 that provide composite, combined or aggregate cost values for all, or subsets of, the linked cost component objects 232. The revenues block 220 is populated with one or more revenue value objects 236 that provide composite, combined or aggregate revenue values for all, or subsets of, the linked revenue component objects 234.

The offer block 204 is populated with offer objects 205 selected in response to the attributes of the offer that are determined by analysis of the offer text strings and field entries, including price, product description, assembly mode, etc. An offer may also be referred to as a value proposition that describes a bundle of products and services that create value for a specific customer segment. Value propositions differentiate one goods or service provider over another, providing solutions to a customer problem, or satisfying a customer need.

The cost objects 230 each have a value or element of risk or probability that is determined as a function of the offer attributes and used to generate and rank cost value objects 234 at 110. Similarly, the revenue objects 232 drive revenue when tied to the offer input information via the offer block 204, objects 205. The objects 205, 230, 232, 234, 236 are components that inherit attributes of the respective panel blocks (204 through 220) that they are located within 108 by analyzing the data of the offer (such as price point, branded goods or internal customer brand, etc.) in view of a respective linked component as a function of attributes and parameters specified by the respective blocks (204 through 220). Some attributes are generic to all offer attributes, and some are added by using library analysis and comparison find the appropriate attributes, for example determining value points, analyzing and finding types of customers and ages, etc., specific to the offer.

The customer segments building block 206 defines different groups of people or organizations an enterprise aims to reach and serve as revenue objects 232 within the block 206. A business model may define one or several large or small customer segments. For example, in order to better satisfy customers aspects of the present invention, it may group them into distinct segments (at 104, FIG. 1) according to common needs, behaviors, or other attributes, and generate revenue and cost values, with relative probability or risk rankings, for the customers as a function of their different respective groupings. Criteria used in creating different customer block 206 revenue objects 232 to represent separate segments, and for creating said groups, include determining that their needs require and justify distinct and different offer attributes; that they are reached through different distribution channels; that they require different types of relationships; that they have substantially different revenue probabilities or cost tolerances; and still other differentiating attributes and group object 232 criteria will be apparent to one skilled in the art.

The revenue objects 232 within the channels building block 208 are linked to the customer segment 206 revenue objects 232 and describe how an organization communicates with and reaches customers to deliver communication, distribution, and sales channels that define an organization's interface with customers with regard to the value proposition of the offer represented by the offer objects 205 within the offer block 204. Channels are customer touch points that play a role in the customer experience and serve several functions. Revenue objects 232 within the channel block 208 including advertising channels used to raise awareness among customers about an organization's products and services, reviewing and advising channels that help customers evaluate an organization's value proposition, direct sales channels that allow customers to purchase specific products and services, and support services that provide post-purchase customer support.

Channels represented by the revenue objects 232 within the channel block 208 can be direct, such as via in-house personnel or internet sites, or they can be indirect, such as separate entities (for example, retail stores) owned or operated by the organization. Partner channels are indirect and span a whole range of options, such as wholesale distribution, retail, or partner-owned internet sites. Each of these attributes can be identified and assigned different probability and revenue values and relative risk and probability rankings, for use in generating values of the revenue value objects 236. For example, partner channels may have lower margins and therefore lower revenue values assigned to their revenue objects 232 relative to those assigned to the revenue objects 232 of direct or indirect channel objects 230. However, partner channels allow an organization to expand its reach and also benefit from partner strengths at lower cost or risk, and therefore the partner channel revenue object 232 will also have a lower risk ranking relative to the values determined for the direct or indirect channels. In some aspects, this may increase weighting or effect of projected revenue relative to the revenue values of the direct or indirect channels. Further, owned channels, and particularly direct ones, have higher margins, but can be costly to put in place and to operate, resulting in a higher risk or lower probability rankings for their projected contributions to the revenues reflected in the revenue value objects 236, relative to the revenues from the partner channels. Aspects of the present invention enable a user to select and vary these channel 208 revenue objects 232 directly, or via different offer inputs, in multiple iterations at 114 to find a desired balance between cost and revenue as a function of relative probability and risk within the channel block 208, for example to integrate them in a way to create a great customer experience while maximizing revenues.

The revenue objects 232 populated within the customer relationships building block 210 describes types of relationships that an organization establishes with the specific customer segments represented by the revenue objects 232 within the customer block 206. Customer relationships may be driven by a variety of motivations, including customer acquisition, customer retention and increasing sales/customer usage of goods and services. Different categories of customer relationships may co-exist in relationship with a particular customer segment 206 revenue object 232, and each may be identified as revenue objects 232 within the customer relationships building block 210 that are assigned different revenue values relative risk and probability rankings. For example, a personal assistance relationship revenue object 232 within the customer relationships block 210 is based on human interaction, wherein a customer can communicate with a real customer representative to get help during the sales process or after the purchase is complete. This may happen onsite at the point of sale, through call centers, by e-mail, or through other means.

A dedicated personal assistance revenue object 232 within the customer relationships block 210 is determined to represent a relationship involving dedicating a customer representative specifically to an individual client. It may represent an intimate type of relationship developed over a long period of time. In private banking services, for example, dedicated bankers serve high net worth individuals. Similar relationships can be found in other businesses in the form of key account managers who maintain personal relationships with important customers.

A self-service object revenue object 232 within the customer relationships block 210 is determined to represent a client or customer contact without direct relationship, providing the necessary means for customers to help themselves via automated services, such as through internet portals. An automated services revenue object 232 within the customer relationships block 210 mixes a more sophisticated form of customer self-service with automated processes. For example, personal online profiles give customers access to customized services. Automated services can recognize individual customers and their characteristics, and offer information related to orders or transactions, and may be capable of approximating attributes of personal relationships, for example by recognizing customer preferences via analysis of historical data and accurately goods or services that meet the customer's needs or expectations.

Values of a communities revenue object 232 within the customer relationships block 210 are populated in response to the utilizing of user communities to engage current or potential customers/prospects and to facilitate connections between community members. Organizations may maintain online communities that allow users to exchange knowledge and solve each other's problems, and these communities may also help the organizations to better understand their customers, in one aspect to thereby learn to better manage customer expectations.

The co-creation revenue object 232 within the customer relationships block 210 is populated with values in response to recognizing co-creative interactions with a client or customer. Some companies go beyond traditional customer-vendor relationships to co-create value with customers. Some companies engage customers to assist with the design of new and innovative products, while others solicit customers to create content for public consumption. For example, Amazon.com® invites customers to write reviews and thus create value for other book lovers. (AMAZON.COM is a trademark of Amazon in the United States and/or other countries.)

The revenue value objects 236 of the revenue streams building block 220 represent gross or net income projected to be generated from the revenue objects 232. The revenue value objects 236 may be differentiated between types of revenue streams. For example, transaction revenue objects 236 have values resulting from one-time customer payments, and while recurring revenue object 232 values come from ongoing payments to deliver goods or services to customers or provide post-purchase customer support. Each revenue stream may have different pricing mechanisms, including fixed list prices and dynamic, variable pricing determined through bargaining, auctioning, market-dependent, volume-dependent, or yield management techniques.

Revenue value objects 236 may also be differentiated as fixed or dynamic, and accordingly with different relative risk and probability rankings or weightings for use of values from linked revenue objects 232 within the revenue blocks 206, 208 and 210. For example, fixed list prices for individual products, services, may have higher probabilities of revenue generation than those set by negotiation (bargaining) between two or more partners, as the agreed price amount will depend (and vary) on relative negotiation power and/or negotiation skills of the parties. Fixed prices that are dependent on product features will depends on the number or quality of value proposition features sold, while yield management prices depend on inventory and demand at the time of purchase and may vary greatly. Customer segment pricing may be fixed and dependent on the type and characteristic of a customer segment serviced, while real-time dynamic market pricing is established dynamically based on supply and demand. Volume dependent pricing is fixed as a function of the quantity of goods or services purchased, while auctions pricing is dynamic and determined by the final outcome of competitive bidding at a fixed or future point in time.

There are many ways to generate revenue streams that may be represented by revenue value objects 236 within the revenue streams building block 220. An asset sale revenue value object 236 generates revenue stream income from selling ownership rights to a physical product. Usage fee revenue value objects 236 generate revenue stream income as fees for the use of a particular service, and generally the more a service is used the more the customer pays, such as for cellular voice and data services.

Subscription fees revenue value objects 236 generate revenue stream income by selling continuous access to a service, for example a gym or internet game portal that sells periodic (monthly, yearly, etc.) subscriptions in exchange for access to its facilities or server resources. Lending, renting and leasing revenue stream revenue value objects 236 are created by temporarily granting someone the right to use a particular asset for a fixed period in return for a fee, generally periodic, recurring revenues. In exchange, the renters or lessee enjoys the benefits of incurring expenses for only a limited time rather than bearing the full costs of ownership, which may be significant for some goods such as automobiles. Licensing revenue stream revenue value objects 236 are generated by giving customers permission to use protected intellectual property in exchange for licensing fees, which allows rights holders to generate revenues from the property while maintaining ownership and without having to manufacture a product or commercialize a service.

Brokerage fees revenue value objects 236 generate revenue streams derived from providing intermediation services for transactions between two or more parties. For example, credit card providers earn revenues by taking a percentage of the value of each sales transaction executed between credit card merchants and customers. Brokers and real estate agents earn a commission each time they successfully match a buyer and seller. Advertising revenue stream revenue value objects 236 realize fees for advertising a particular product, service, or brand on media outlets such as television, radio, internet streaming and social network services.

The cost objects 230 within the key resources building block 212 describe key or necessary assets required to make the displayed business model work. Key resources are generally those that allow an enterprise to create and offer a value proposition, reach markets, maintain relationships with the revenue objects 232 within the customer segments block 206, and earn revenues. Different key resource block 212 cost objects 230 are needed depending on the type of business model. For example, a manufacturer may require capital-intensive production facility cost objects 230, whereas a designer focuses more on human resources cost objects 230.

Key resource block 212 cost objects 230 may be categorized as physical, intellectual property, human or financial, and may be owned or leased by the company or acquired from key partner cost objects 230 within the key partner block 216 described below. The physical category includes physical assets such as manufacturing facilities, buildings, vehicles, machines, systems, point-of-sales systems, and distribution networks. Intellectual property resources include brands, proprietary knowledge (including trade secret, partnership agreements and customer databases), patents and copyrights. Human resources may be highly valued in knowledge-intensive and creative industries, and therefore such cost objects 230 within business plans involving these industries may have higher relative risk and probability rankings or weightings than the valuations used in commodity industries. Financial resources and/or financial guarantees, such as cash, lines of credit, or stock option pools for hiring and retaining key employees, also define cost objects 230 with differentiated cost values and risk and probability rankings or weightings.

The key activities building block 214 includes cost objects 230 that represent tasks needed to make the business model work. Like the key resource block 212 cost objects 230 they are required to create and offer a value proposition, reach markets via the channel revenue objects 232 with the channels block 208, maintain customer relationship revenue objects 232 within the customer relationships block 210, in order to earn revenues. Key activities cost objects 230 may be differentiated depending on business model type. For software makers key activities include software development cost objects 230, while computer manufacturers' key activities include supply chain management cost objects 230. Consultancy key activities include problem solving cost objects 230.

Key activities may also be categorized as production, problem solving or platform activity cost objects 230. Production activities relate to designing, making, and delivering a product in acceptable quantities and/or of acceptable quality, and typically is a dominant factor in the manufacturing firm business models. Problem solving activities relate to coming up with new solutions to individual customer problems, and these have high importance (and therefore relatively higher factor valuations in aspects of the present invention) in the operations of consultancies, hospitals, and other service organizations. Platform or network, activities are highly valued in networks, matchmaking platforms and software services domains. In some aspects, trademarks and brands function as platform cost objects 230, particularly when the valuation of the organization is tied strongly to a brand or market identity,

The partner's building block 216 includes cost objects 230 that represent a network of suppliers and partners that make the business model work. Such alliances may optimize business models, reduce risk, or be useful in acquiring resources. Partner's building block 216 cost objects 230 may be distinguished between different types of partnerships, including strategic alliances between non-competitors or between competitors, joint ventures to develop new businesses, and buyer-supplier relationships that assure reliable supplies,

Partner's building block 216 cost objects 230 may also be distinguished based on different motivations for creating the partnerships. Optimization and economy of scale cost objects 230 reflect a partnership or buyer-supplier relationship designed to optimize the allocation of resources and activities, enabling an organization to reduce costs through outsourcing or sharing infrastructure. The reduction of risk and uncertainty may also motivate a specific partnership cost object 230, to help reduce risk in a competitive environment characterized by uncertainty. It is not unusual for competitors to form a strategic alliance in one area while still competing in another.

An acquisition partnership cost object 230 within the partnership block 216 represents a partnership for the acquisition of resources or activities from another. An organization may not own all the resources needed or perform all the activities described by a business model. Accordingly, they may extend their own capabilities by relying on other firms to furnish particular resources or perform certain activities. Acquisition partnership cost objects 230 may represent a partnership to acquire knowledge, licenses, or access to customers.

The cost value objects 234 within the cost structure block 218 display the costs incurred in operating the linked cost objects 230 of the business model displayed in the canvas 202. The cost value objects 234 may be distinguished as cost-driven or value-driven, though some business model objects may fall in between. Cost-driven cost value objects 234 defined by business models focus on minimizing costs to create and maintain a low cost structure, such as by using low price value propositions, maximizing automation, and extensively using outsourcing options. In contrast, value-driven cost value objects 234 defined by business models are less concerned with the cost implications of a particular business model design and instead focus on value creation. Premium value propositions and a high degree of personalized service usually characterize value-driven business models.

The cost value objects 234 within the cost structure block 218 may be distinguished based on fixed cost, variable cost, economy of scale and economy of scope attributes. Fixed costs are the costs that remain the same despite the volume of goods or services produced; examples include salaries, rents, and physical manufacturing facilities construction costs. Some businesses, such as manufacturing companies, are characterized by a high proportion of fixed costs. Variable costs vary proportionally with the volume of goods or services produced. Economies of scale capture the cost advantages that a business enjoys as its output expands. Larger companies, for instance, benefit from lower bulk purchase rates, and this may cause average cost-per-unit to fall as output rises. Economies of scope describe cost advantages that a business enjoys due to a larger scope of operations. In a large enterprise, for example, the same marketing activities or distribution channel represented by a revenue object 232 within the channels block 208 may support multiple products.

In aspects of the present invention, the values and factors assigned to the canvas objects 205, 230, 232, 234 and 236 within the library 106 are learned or determined in response to the expert business knowledge of individuals, for example, by surveys, brainstorming, etc. This knowledge is captured as initial values, which are varied in application to the canvas 202 by ascertaining weight factors, determining attributes preferences, risks and probabilities relative to other attributes to give a holistic picture of a business plan with quantifiable values displayed within the cost value objects 234 and the revenue value objects 236 to enable objective assessment of each business plan iteration.

The variation input at 114 may include directly deleting or adding objects 205, 230, 232, 234 and 236 between iterations. For example, in response to recognizing that brick-and-mortar store revenue objects 232 will not be used, said objects may be deleted from the channels block 208 to trigger another iteration of the business plan. Objects 205, 230, 232, 234 or 236 may also be added to the displayed business plan by dragging and dropping component objects 242 from a component block 240 in a graphical user interface (GUI) display of the canvas 202 directly into any of the nine blocks 204 through 220, wherein the dropped component object 242 will inherit the correct data elements of the receiving blocks 204 through 220 to capture the financial, impact, risk and probability variables and factors of that block. For example, when capturing a resource component 242 such as a data center, the cost, performance, depreciation value, types of technology supported today or other user defined variables will be associated with the component as a function of the respective blocks 204 through 220. This capturing of details enables a user of the canvas 202 to ensure that they've considered the additional attributes impacting the business model displayed, and also provides a direct feed into risk and outcome probability simulations for execution by analytical engines of the canvas 202.

The canvas 202 thereby captures relevant variables for a future business direction, using the visualizers of the collaborative ideas all on one page, optionally with proper color coding and relationship mapping, while feeding input data into simulation analytical models to show risk and outcome probability and fast-track the innovation process while reducing the risk of making a wrong bet in changing business directions.

Capturing the variables associated with each component 242 or object 205, 230, 232, 234 and 236 can be done by filling in existing variables associated with each business block 204 through 220, on the cost or the revenue side of the canvas 202. Relationship mapping between the component objects 205, 230, 232, 234 and 236 and business blocks 204 through 220, and permutations of target state models, enables users to quickly explore options during modeling and ideation phases. Evaluation of captured models as a function of predictive models identifies best possible outcomes based on generated ideas and inputs. A portfolio analyzer of the business model may be executed with a Capital Asset Pricing Model (CAP-M), which will predict the highest possible return. Using a Delphi Method for the derived output will allow further analysis to be done on the target state business models. Risk assessment analytics may be carried out against the selected models to identify the low-to-high risk potential for each model. Using Probabilistic Risk Assessment (PRA) predictive modeling along with the Analysis of Alternatives (AoA) modeling will provide a risk score that can be analyzed in combination with the CAP-M outputs.

Referring now to FIG. 3, an exemplary computerized implementation of an aspect of the present invention includes a computer system or other programmable device 522 in communication 520 with the pre-coded components library 106, an input data source 502 for provision of offer inputs, and a display device 506 for generating and displaying a business model as described above with respect to FIGS. 1 and 2. Instructions 542 reside within computer readable code in a computer readable memory 516, or in a computer readable storage system 532, or other tangible computer readable storage medium 534 that is accessed by a Central Processing Unit (processor or CPU) 538 of a computer system or infrastructure 523 of the programmable device 522. Thus, the instructions, when implemented by the processor 538, cause the processor 538 to generate and display a business model as described above with respect to FIGS. 1 and 2.

In one aspect, the present invention may also perform process steps of the invention on a subscription, advertising, and/or fee basis. That is, a service provider could offer to integrate computer-readable program code into the computer system 522 to enable the computer system 522 to generate and display a business model as described above with respect to FIGS. 1 and 2. The service provider can create, maintain, and support, etc., a computer infrastructure, such as the computer system 522, network environment 520, or parts thereof, that perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 522, from a tangible computer-readable medium device 532 or 534; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The aspect was chosen and described in order to best explain the principles of the invention and the practical application, and to enable others of ordinary skill in the art to understand the invention for various embodiments with various modifications as are suited to the particular use contemplated.

The flowchart and block diagrams in the figures illustrate the architecture, functionality, and operation of possible implementations of systems, methods and computer program products according to various aspects of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for automated business model generation, the method comprising:
a processor comparing text strings of an input offer against each of a plurality of pre-coded business plan components to identify constituent attribute text strings of the input offer that are relevant to at least one cost component and at least one revenue component of the pre-coded cost and revenue business plan components within a matching threshold;
the processor generating a business plan for the input offer by linking the pre-coded business plan components that are identified as associated with the input offer constituent attribute text strings within the matching threshold, wherein the linked components include the at least one cost component and the at least one revenue component; and
the processor combining cost values assigned to the linked at least one cost component and revenue values assigned to the at least one revenue component to generate composite cost and revenue values for the generated business plan as a function of probability weighting factors that are selected for the at least one cost component and the at least one revenue component as a function of entity identity attributes of the input offer.

2. The method of claim 1, further comprising:
integrating computer-readable program code into a computer system comprising the processor, a computer readable memory and a computer readable storage medium, wherein the computer readable program code is embodied on the computer readable storage medium and comprises instructions that, when executed by the processor via the computer readable memory, cause the processor to perform the steps of the comparing input offer text strings against the pre-coded business plan components to identify the input offer constituent attribute text strings that are relevant to the at least one cost component and the at least one revenue component within the matching threshold, generating the business plan for the input offer and combining the cost values assigned to the linked at least one cost component and the revenue values assigned to the at least one revenue component to generate the composite cost and revenue values for the generated business plan.

3. The method of claim 1, wherein the step of comparing the input offer text strings against the pre-coded business plan components to identify the input offer constituent attribute text strings that are relevant to the at least one cost component and the at least one revenue component of the pre-coded cost and revenue business plan components within the matching threshold comprises:
using an extract, transform and load process to extract the input data from an original input source;
transforming the extracted data to fit operational needs of a library system that includes the pre-coded business plan components; and
loading the transformed data into the library system as an end target to compare to component and object data within the library system.

4. The method of claim 3, wherein the step of comparing the input offer text strings against the pre-coded business plan components to identify the input offer constituent attribute text strings that are relevant to the at least one cost component and the at least one revenue component of the pre-coded cost and revenue business plan components within the matching threshold comprises:
determining match values as percentages of similarity of phrases identified within the input offer text strings to phrases associated with the pre-coded cost and revenue business plan components.

5. The method of claim 1, further comprising:
displaying the linked pre-coded business plan components in a business plan format that indicates the composite cost and revenue values for the generated business plan as a function of different respective values or risk or probability.

6. The method of claim 5, wherein the step of displaying the linked pre-coded business plan components in the business plan format comprises:
populating an offer block within a display with at least one offer object that is selected to represent at least one of the constituent attribute text strings that are relevant to the at least one cost component and the at least one revenue component of the pre-coded cost and revenue business plan components within the matching threshold;
automatically populating a cost block within the display with at least one cost object that is linked to at least one offer object; and
generating the composite cost value for the generated business plan as a function of a probability weighting factor that is selected for a first of the at least one cost object as a function of a category attribute of the cost block.

7. The method of claim 6, further comprising:
adding a component object from the library to the cost block;
in response to the adding the component object to the cost block, the component object inheriting cost data elements of the cost block;
using the inherited cost data elements to capture at least one of risk and probability weightings that are relevant to the constituent attribute text strings within the matching threshold;
generating the composite cost value for the generated business plan as a function of the captured probability value that is relevant to the constituent attribute text strings within the matching threshold; and
displaying the linked pre-coded business plan components in the business plan format that indicates the composite cost and revenue values for the generated business plan as the function of different respective values or risk or probability by distinctively indicating that a second displayed revenue object has a higher risk than a third displayed revenue object.

8. The method of claim 7, wherein the step of adding the component object from the library to the cost block comprises dragging and dropping the component object within a graphical user interface display.

9. A system, comprising:
a processor in circuit communication with a computer readable memory and a computer readable storage medium;
wherein the processor, when executing program instructions stored on the computer-readable storage medium via the computer readable memory:
compares text strings of an input offer against each of a plurality of pre-coded business plan components to identify constituent attribute text strings of the input offer that are relevant to at least one cost component and at least one revenue component of the pre-coded cost and revenue business plan components within a matching threshold;
generates a business plan for the input offer by linking the pre-coded business plan components that are identified as associated with the input offer constituent attribute text strings within the matching threshold, wherein the linked components include the at least one cost component and the at least one revenue component; and
combines cost values assigned to the linked at least one cost component and revenue values assigned to the at least one revenue component to generate composite cost and revenue values for the generated business plan as a function of probability weighting factors that are selected for the at least one cost component and the at least one revenue component as a function of entity identity attributes of the input offer.

10. The system of claim 9, wherein the processor, when executing the program instructions stored on the computer-readable storage medium via the computer readable memory, compares the input offer text strings against the pre-coded business plan components to identify the input offer constituent attribute text strings that are relevant to the at least one cost component and the at least one revenue component of the pre-coded cost and revenue business plan components within the matching threshold by:
using an extract, transform and load process to extract the input data from an original input source;
transforming the extracted data to fit operational needs of a library system that includes the pre-coded business plan components; and
loading the transformed data into the library system as an end target to compare to component and object data within the library system.

11. The system of claim 10, wherein the processor, when executing the program instructions stored on the computer-readable storage medium via the computer readable memory, compares the input offer text strings against the pre-coded business plan components to identify the input offer constituent attribute text strings that are relevant to the at least one cost component and the at least one revenue component of the pre-coded cost and revenue business plan components within the matching threshold by determining match values as percentages of similarity of phrases identified within the input offer text strings to phrases associated with the pre-coded cost and revenue business plan components.

12. The system of claim 9, wherein the processor, when executing the program instructions stored on the computer-readable storage medium via the computer readable memory, displays the linked pre-coded business plan components in a business plan format that indicates the composite cost and revenue values for the generated business plan as a function of different respective values or risk or probability.

13. The system of claim 12, wherein the processor, when executing the program instructions stored on the computer-readable storage medium via the computer readable memory, displays the linked pre-coded business plan components in the business plan format by:
populating an offer block within a display with at least one offer object that is selected to represent at least one of the constituent attribute text strings that are relevant to the at least one cost component and the at least one revenue component of the pre-coded cost and revenue business plan components within the matching threshold;
automatically populating a cost block within the display with at least one cost object that is linked to at least one offer object; and
generating the composite cost value for the generated business plan as a function of a probability weighting factor that is selected for a first of the at least one cost object as a function of a category attribute of the cost block.

14. The system of claim 13, wherein the processor, when executing the program instructions stored on the computer-readable storage medium via the computer readable memory, further:
adds a component object from the library to the cost block;
in response to the addition of the component object to the cost block, causes the component object to inherit cost data elements of the cost block;
uses the inherited cost data elements to capture at least one of risk and probability weightings that are relevant to the constituent attribute text strings within the matching threshold;
generates the composite cost value for the generated business plan as a function of the captured probability value that is relevant to the constituent attribute text strings within the matching threshold; and
displays the linked pre-coded business plan components in the business plan format that indicates the composite cost and revenue values for the generated business plan as the function of different respective values or risk or probability by distinctively indicating that a second displayed revenue object has a higher risk than a third displayed revenue object.

15. A computer program product for automated business model generation, the computer program product comprising:
a computer readable storage medium having computer readable program code embodied therewith, the computer readable program code comprising instructions that, when executed by a processor, cause the processor to:
compare text strings of an input offer against each of a plurality of pre-coded business plan components to identify constituent attribute text strings of the input offer that are relevant to at least one cost component and at least one revenue component of the pre-coded cost and revenue business plan components within a matching threshold;
generate a business plan for the input offer by linking the pre-coded business plan components that are identified as associated with the input offer constituent attribute text strings within the matching threshold, wherein the linked components include the at least one cost component and the at least one revenue component; and
combine cost values assigned to the linked at least one cost component and revenue values assigned to the at least one revenue component to generate composite cost and revenue values for the generated business plan as a function of probability weighting factors that are selected for the at least one cost component and the at least one revenue component as a function of entity identity attributes of the input offer.

16. The computer program product of claim 15, wherein the computer readable program code instructions, when executed by the processor, further cause the processor to compare the input offer text strings against the pre-coded business plan components to identify the input offer constituent attribute text strings that are relevant to the at least one cost component and the at least one revenue component of the pre-coded cost and revenue business plan components within the matching threshold by:
using an extract, transform and load process to extract the input data from an original input source;
transforming the extracted data to fit operational needs of a library system that includes the pre-coded business plan components; and
loading the transformed data into the library system as an end target to compare to component and object data within the library system.

17. The computer program product of claim 16, wherein the computer readable program code instructions, when executed by the processor, further cause the processor to compare the input offer text strings against the pre-coded business plan components to identify the input offer constituent attribute text strings that are relevant to the at least one cost component and the at least one revenue component of the pre-coded cost and revenue business plan components within the matching threshold by determining match values as percentages of similarity of phrases identified within the input offer text strings to phrases associated with the pre-coded cost and revenue business plan components.

18. The computer program product of claim 15, wherein the computer readable program code instructions, when executed by the processor, further cause the processor to display the linked pre-coded business plan components in a business plan format that indicates the composite cost and revenue values for the generated business plan as a function of different respective values or risk or probability.

19. The computer program product of claim 18, wherein the computer readable program code instructions, when executed by the processor, further cause the processor to display the linked pre-coded business plan components in the business plan format by:
populating an offer block within a display with at least one offer object that is selected to represent at least one of the constituent attribute text strings that are relevant to the at least one cost component and the at least one revenue component of the pre-coded cost and revenue business plan components within the matching threshold;
automatically populating a cost block within the display with at least one cost object that is linked to at least one offer object; and
generating the composite cost value for the generated business plan as a function of a probability weighting factor that is selected for a first of the at least one cost objects as a function of a category attribute of the cost block.

20. The computer program product of claim 19, wherein the computer readable program code instructions, when executed by the processor, further cause the processor to further:
add a component object from the library to the cost block;
in response to the addition of the component object to the cost block, cause the component object to inherit cost data elements of the cost block;
use the inherited cost data elements to capture at least one of risk and probability weightings that are relevant to the constituent attribute text strings within the matching threshold;
generate the composite cost value for the generated business plan as a function of the captured probability value that is relevant to the constituent attribute text strings within the matching threshold; and
display the linked pre-coded business plan components in the business plan format that indicates the composite cost and revenue values for the generated business plan as the function of different respective values or risk or probability by distinctively indicating that a second displayed revenue object has a higher risk than a third displayed revenue object.
